(19) United States
(12) Patent Application Publication
(10) Pub. No.: US 2015/0072094 A1
(43) Pub. Date: Mar. 12, 2015

(54) SYNTHETIC FILM PRIMARILY CONSISTING OF BIODEGRADABLE POLYMERS

(71) Applicant: HUHTAMAKI FILMS GERMANY GMBH & CO. KG, Forchheim (DE)

(72) Inventors: Karl Mauser, Leutenbach (DE); Kurt Stark, Neuhaus (DE); Christian Schuetz, Kirchehrenbach (DE)

(73) Assignee: HUHTAMAKI FILMS GERMANY GMBH & CO. KG, Forchheim (DE)

(21) Appl. No.: 14/390,266

(22) PCT Filed: Mar. 25, 2013
(86) PCT No.: PCT/EP2013/000895

§ 371 Date: Oct. 2, 2014

(30) Foreign Application Priority Data
Apr. 2, 2012 (DE) 10 2012 006 598.1

(51) Int. Cl. B32B 27/08; B32B 27/32; C08J 5/18; B32B 27/36

(52) U.S. Cl. CPC B32B 27/08; B32B 27/36; B32B 27/32; C08J 5/18; B32B 2250/244; B32B 2307/5825; B32B 2307/7163; B32B 2250/246; C08J 2451/06; C08J 2367/04
USPC 428/36.92; 428/483; 428/354; 428/195.1; 428/35.7; 53/396; 525/64; 524/504

(57) ABSTRACT

The present invention relates to a single- or multi-layered synthetic film primarily consisting of biodegradable polymers, said synthetic film consisting of one or more layers (a) of at least one biodegradable polymer and 1-35% by weight, relative to the total weight of the layer (a), of at least one modified, thermoplastic copolymer of α,β-unsaturated olefins having 2-10 carbon atoms and (meth)acrylic acid and/or at least one (meth)acrylic acid derivative that is grafted, preferably with cyclic anhydride groups and/or carboxyl groups and/or ester groups, said invention further relating to a use of such a synthetic film as packaging material.

The present invention relates to a single-layer or multilayer polymer film which is made up of predominantly biodegradable polymers and has a tear propagation resistance of preferably at least 30N (DIN 53363 Trapez) and consists of at least one, preferably interior layer (a) composed of a mixture of at least one biodegradable polymer and up to a maximum of 35% by weight, based on the total weight of the layer (a), of at least one modified, thermoplastic copolymer composed of α,β-unsaturated olefins having 2-10 carbon atoms and (meth)acrylic acid and/or at least one (meth)acrylic acid derivative, which is in each case grafted, preferably with cyclic anhydride groups and/or carboxyl groups and/or ester groups, optionally of at least one plasticizer and optionally of one or more commonly used additives, and use of such a polymer film as packaging material.

Polymer films based on biodegradable raw materials are being used as packaging material increasingly, in particular when this material is not only biodegradable but can also be obtained from renewable raw materials.

From the prior art known disadvantages of these polymer films are often unsuitable mechanical properties, for example insufficient toughness, and unsatisfactory tear propagation resistance.

Furthermore, biodegradable polymers are often not compatible with other polymers, in particular those obtained from fossil raw materials such as petroleum, so that an improvement of the mechanical properties of biodegradable polymers or products produced therefrom by blending with thermoplastic polymers derived from fossil raw materials does not lead to the desired improved mechanical properties.

It was therefore an object of the present invention to provide polymer films made of biodegradable polymers which are, inter alia, significantly improved in terms of their toughness and tear propagation resistance.

This object is achieved by provision of predominantly biodegradable, single-layer or multilayer polymer films consisting of

at least one layer (a) made up of a mixture of at least one biodegradable polymer and up to a maximum of 35% by weight, based on the total weight of the layer (a), of at least one modified, thermoplastic copolymer composed of α,β-unsaturated olefins having 2-10 carbon atoms and (meth)acrylic acid and/or at least one (meth)acrylic acid derivative, which is grafted, preferably with cyclic anhydride groups and/or carboxyl groups and/or ester groups, optionally of at least one plasticizer and of optionally one or more commonly used additives;

whereby the other layers which are optionally present consist of at least one biodegradable polymer, optionally a modified, thermoplastic copolymer of α,β-unsaturated olefins having 2-10 carbon atoms and (meth)acrylic acid and/or at least one (meth)acrylic acid derivative, which may be grafted in each case preferably with cyclic anhydride groups and/or carboxyl groups and/or ester groups, optionally at least one plasticizer; and optionally one or more commonly used additives, and

the total proportion of the modified, thermoplastic copolymers of the polymer film, based on the total weight of the polymer film, is not more than 15% by weight and

the polymer film has no adhesion promoting layer.

Preferably, the inventive polymer films have a tear propagation resistance of at least 30N measured in accordance with DIN 53363-Trapez in the machine direction at a total thickness of 200 μm.

Preferably, the inventive polymer films do not have any further layer having an amount of the modified, thermoplastic copolymer component exceeding the maximum indicated amount of said copolymer component for layer a).

The polymer films of the invention preferably do not contain any polymers having aromatic units.

For the purposes of the present invention, the term “biodegradable” refers to a natural, semisynthetic or synthetic polymer in any form, e.g. as one layer of a multilayer polymer film, which can be decomposed under the action of microorganisms and/or enzymes to give water, carbon dioxide and biomass in accordance with DIN EN 13432 and achieves a biodegradation of at least 90%, preferably at least 95%, particularly preferably ≧99%, after 12 weeks of aerobic composting in the disintegration test.

According to a preferred embodiment of the inventive polymer films, the entire polymer films are predominantly biodegradable, i.e. the entire polymer films are degraded to an extent of more than 50% by weight, preferably more than 70% by weight, particularly preferably more than 80% by weight, after 12 weeks when subjected to the above-described method. For the purposes of the present invention, the term “made up of” means that the polymer films or the respective layer of the polymer films contain the component respectively components referred to by this term as main constituent, respectively constituents, i.e. consist to an extent of more than 50% by weight of the component respectively these components. The polymer films or the respective layer of the polymer films preferably consist predominantly of these component(s), i.e. preferably to an extent of more than 70% by weight, particularly preferably more than 80% by weight and very particularly preferably up to 100% by weight.

The inventive polymer films have at least one layer (a) made up of a mixture of at least one biodegradable polymer and up to a maximum of 35% by weight, based on the total weight of the layer (a), of at least one modified, thermoplastic copolymer composed of α,β-unsaturated olefins having 2-10 carbon atoms and (meth)acrylic acid and/or at least one (meth)acrylic acid derivative, which is grafted preferably with cyclic anhydride groups and/or carboxyl groups and/or ester groups of optionally at least one plasticizer and of optionally one or more customary additives.

The layer(s) (a) is or are preferably interior layer or layers in the case of inventive multilayer polymer films, which preferably have at least three layers, of which preferably each layer being predominantly biodegradable.

In a preferred embodiment of the inventive polymer films, the polymer films have at least five layers, of which preferably all of the layers of the polymer films having at least one biodegradable polymer as main constituent.

The inventive polymer films can have one layer (a) or a plurality of, preferably two, layers (a). If the polymer films of the invention have a plurality of layers (a), these layers can have the same composition or different compositions, with the proportion of modified, thermoplastic copolymers not being allowed to exceed 35% by weight, based on the total weight of one layer (a), and the total proportion of the modified, thermoplastic copolymers in the multilayer inventive polymer film need not exceed 15% by weight, based on the total weight of the polymer film.

In a preferred embodiment of the inventive polymer films, the total proportion of the biodegradable polymers is at least 75% by weight, preferably at least 80% by weight, particularly preferably at least 85% by weight, based on the total weight of the respective polymer film.

According to a preferred embodiment, the biodegradable polymer of the inventive polymer films is a biodegradable, synthetic polymer.

In a further preferred embodiment, at least one biodegradable polymer of the inventive polymer film is a biodegradable aliphatic polyester.

Preferably as biodegradable polymers for producing the layer or layers of the inventive polymer films is at least one biodegradable polymer selected from the group comprising lactic acid homopolymers and copolymers, preferably polylactides composed of D-lactide and L-lactide (PDLLA) or of L-lactide (PLLA) or D-lactide (PDLA), polyhydroxyalkanoates, cellulose, cellulose derivatives, thermoplastic starch, polyesters derived from lactones having from 4 to 10 carbon atoms, preferably polycaprolactones, copolymers of at least two monomers of the abovementioned polymers and mixtures of at least two of the polymers mentioned.

According to the invention, particular preference is given to using polycaprolactones and/or polylactides as biodegradable polyesters.

In case the inventive polymer film is a multilayer film, the biodegradable polymers of the individual layers can be of the same type or different. In a particularly preferred embodiment of an inventive polymer film which is a multilayer film, the biodegradable polymers of the individual layers are of the same type.

For the purposes of the invention, the terms “lactic acid homopolymer”, “lactic acid copolymer”, “polylactides (PLA)” refer to homopolymers or copolymers of lactic acid, regardless of whether they are produced from lactic acid, lactide oligomers or at least one lactide.

Lactides are cyclic condensation products of two lactic acid molecules. They can be derived from two D-lactic acid molecules, two L-lactic acid molecules or from one D-lactic acid molecule and one L-lactic acid molecule and accordingly are referred to as D-lactides, L-lactides or D,L-lactides (meso-lactides). Polylactides can preferably be obtained by catalytic ring-opening polymerization of lactides. Here, it is possible to use D-lactides, L-lactides and/or D,L-lactides (meso-lactides).

The layer(s) of the inventive polymer films preferably consist of at least one polylactide, preferably selected from the group consisting of poly-L-lactides, poly-D-lactides, poly-DL-lactides and isomeric, optionally racemic, mixtures of a poly-L-lactide and a poly-D-lactide, as the main biodegradable component.

According to a preferred embodiment of the inventive polymer films, the polymer films consist of at least one polylactide as biodegradable polymer in at least two layers, preferably in all layers, whereby the polylactide component can be identical in all layers or different.

In a further preferred embodiment of the inventive polymer films at least two layers of, the polymer films have the same polylactide component, layer thickness and optionally composition.

The layer or layers (a) of the polymer films of the invention contains or contain up to a maximum of 35% by weight, preferably 1-30% by weight, particularly preferably 5-25% by weight, based on the total weight of the respective layer (a), of at least one modified, thermoplastic copolymer composed of α,β-unsaturated olefins having 2-10 carbon atoms and (meth)acrylic acid and/or at least one (meth)acrylic acid derivative, which is grafted, preferably with cyclic anhydride groups and/or carboxyl groups and/or ester groups.

Except the layer or layers (a), the inventive polymer films preferably do not comprise any layers in which the maximum amount of the modified, thermoplastic copolymer component exceeds the respective amount indicated for the composition of the layer (a).

According to a preferred embodiment, the total proportion of the modified, thermoplastic copolymers of the inventive polymer film is not more than 10% by weight, based on the total weight of the polymer film.

As modified, thermoplastic copolymers thermoplastic copolymers of α,β-unsaturated olefins having 2-10 carbon atoms and (meth)acrylic acid and/or at least one (meth)acrylic acid derivative, which is grafted, preferably with carboxyl groups and/or corresponding derivatives such as, preferably, ester groups and/or anhydride groups, particularly preferably cyclic anhydride groups, in particular maleic anhydride groups can be used.

Particularly suitable modified, thermoplastic copolymers which are used for the inventive predominantly biodegradable polymer films as, inter alia, a component which improves the tear propagation resistance, are at least one copolymer selected from the group comprising copolymers of ethylene and methacrylic acid and/or at least one methacrylic acid derivative and/or methacrylate, and copolymers of ethylene and acrylic acid and/or at least one acrylic acid derivative and/or acrylate, in each case grafted, preferably with cyclic anhydride groups, preferably maleic anhydride groups, and/or carboxyl groups and/or ester groups.

Very preferably, copolymers of ethylene-methyl methacrylate copolymers or ethylene-methyl acrylate copolymers which are grafted with maleic anhydride groups can be used.

Each of the layers of the inventive polymer films can, in each case independently of one another, be dosed with commonly usedadditives. The commonly used additives are preferably selected from the group comprising antioxidants, antiblocking agents, antifogging agents, antistatics, antimicrobially active compounds, light stabilizers, UV absorbers, dyes, color pigments, stabilizers, preferably heat stabilizers, process stabilizers and UV and/or light stabilizers, preferably based on at least one sterically hindered amine (HALS), processing aids, flame retardants and nucleating agents. Such additives are preferably used in case they are biodegradable.

The proportion of the abovementioned additives, if they are present in a layer, can in each case be 0.01-30% by weight, preferably 0.01-20% by weight, particularly preferably 0.1-5% by weight, based on the total weight of the individual layer.

According to a preferred embodiment, one or more layers of the inventive polymer films can contain at least one plasticizer, preferably at least one polymeric plasticizer, very particularly preferably at least one high molecular weight plasticizer such as at least one polyalkylene oxide having a molecular weight of ≧20 000 g/mol, preferably ≧25 000 g/mol.

In a preferred embodiment of the inventive polymer films, the polymer films contain at least one polyethylene glycol and/or polypropylene glycol as plasticizer. The use of polyethylene glycol having a molecular weight of ≧20 000 g/mol, preferably ≧25 000 g/mol, as plasticizer is particularly preferred.

In a preferred embodiment, at least one layer (a) of the inventive polymer films can comprise plasticizers, preferably in an amount of 1-20% by weight, particularly preferably 5-15% by weight, based on the total weight of the layer (a). Each layer of the inventive polymer film can preferably contain a plasticizer, optionally in different amounts.

The inventive polymer films preferably contain the plasticizer in an amount of 1-15% by weight, particularly preferably 3-10% by weight, based on the total weight of the polymer film.

This total content of plasticizers can be divided among not only layers (a) but also any further layers present, in particular further interior layers of the inventive polymer films. Here, the content of the plasticizer, if present in one layer, can, in each case independently of the plasticizer content of any further layers present, preferably be in each case 1-20% by weight, particularly preferably 5-15% by weight, based on the total weight of the individual layer.

The plasticizer content in at least one interior layer is preferably greater than in the surface layers.

In a preferred embodiment, at least one, preferably all, interior layers of the inventive polymer films contain plasticizers and surface layers do not contain any plasticizer.

The inventive predominantly biodegradable polymer films are distinguished from conventional polymer films based on biodegradable polymers in that they have improved mechanical properties, for example increased toughness, preferably increased tear propagation resistance.

Furthermore, the inventive polymer films are distinguished by being able to be produced both by conventional cast film extrusion processes and by conventional blown film extrusion processes, with extrusion also being able to be carried out by coextrusion and the cast film extrusion process preferably with the aid of flat film dies being preferred.

The inventive polymer films can also be produced by lamination.

The inventive polymer films can be produced and processed in the form of individual layers, as partial composite or as complete multilayer films, optionally also in the form of tubular films.

In a preferred embodiment, at least part of the inventive polymer films, preferably consisting of at least one layer (a) and at least two further biodegradable layers, is produced in the form of a cast film (as flat film extrudate).

In a further preferred embodiment, the entire inventive polymer films can be produced in the form of a coextruded cast film.

In a further embodiment, the inventive polymer film can be produced as a multilayer blown film, by extrusion, preferably by blown film coextrusion.

During the production of the inventive polymer films, the film tube can be blown up to a blowing-up ratio of preferably from 1:1.5 to 1:3 and a drawing ratio of preferably from 100:1 to 12:1, particularly preferably from 60:1 to 12:1, in order to effect biaxial orientation.

If necessary, the polymer films produced as cast films can also be at least monoaxially oriented, preferably in the longitudinal or transverse direction, in a stretching ratio of at least 1:1.5, preferably at least 1:2, particularly preferably from 1:2 to 1:4, or biaxially, i.e. in the longitudinal and transverse directions, in each case in a stretching ratio of from 1:1.5 to 1:10, particularly preferably from 1:2 to 1:4.

The extruded films can be stretched to the desired extent during production or preferably directly after extrusion.

The orientation is preferably maintained during the further processing steps.

The respective preparation processes and corresponding production parameters are common knowledge and familiar to a person skilled in the art.

The inventive predominantly biodegradable polymer films can also preferably be provided with a pressure-sensitive adhesive layer by coating or lamination of one of their surfaces. To protect the adhesive layer, the layer can optionally be provided with a removable protective film or a removable protective layer as covering in a subsequent working step.

The inventive polymer films can optionally have peeling properties, for example in the form of a biodegradable peelable layer.

In a preferred embodiment, the inventive polymer films are transparent.

The inventive predominantly biodegradable polymer film can be printed, coated, preferably siliconized or metalized, and/or colored.

The inventive polymer film is preferably suitable as packaging material for various consumer goods, for example for foodstuffs, flowers or plants, since the polymer film is predominantly biodegradable.

The present invention therefore further provides for the use of an inventive, preferably transparent polymer film as a predominantly biodegradable packaging material for consumer goods such as foodstuffs, preferably vegetables, fruit, meat products, for flowers or plants, or corresponding packaging containing these products.

An inventive transparent polymer film is also suitable as viewing window for otherwise nontransparent packaging made of biodegradable materials. In particular, an inventive, transparent polymer film can serve as predominantly biodegradable viewing window for nontransparent, biodegradable cardboard packaging or envelopes.

The inventive polymer film can also, when provided with a pressure-sensitive adhesive layer, be used as predominantly biodegradable labels, or optionally printed as predominantly biodegradable protective or decorative film for books or cartons.

The present invention therefore further provides the use of the polymer film as a predominantly biodegradable viewing window for preferably otherwise nontransparent packaging, preferably cardboard packaging, preferably for foodstuffs, as viewing window of envelopes, as predominantly biodegradable sticker which is optionally provided with a pressure-sensitive adhesive layer, as predominantly biodegradable, inscribed or uninscribed labels or optionally printed as predominantly biodegradable protective or decorative film for books and cartons, and also the corresponding products.

The following examples serve to illustrate the invention, but should not be interpreted as constituting a restriction.

### I. Chemical Characterization of the Raw Materials Used

| | |
|---|---|
| PLA 2003 D: | Polylactide from Nature Works ® LLC |
| Coex-Inline PLA | PLA 2003 D |
| Compound PLA/PEG-35000S- | Compound made up of PLA 2003 D and |
| 15% | 15% by weight of polyethylene glycol |
| | having an average molecular weight of |
| | 35000 g/mol |
| PLA DC S 511 | Masterbatch of PLA DC S 511 from |
| Slip/Antiblock/Clarifier - | Sukano with 7% by weight of |
| 7% | slip/antiblock/clarifier additives |
| Bynel 21 E 787 | Ethylene-methyl acrylate copolymer |
| | grafted with maleic anhydride |
| Bynel 21 E 830 | Ethylene-methyl acrylate copolymer |
| | grafted with maleic anhydride |
| Sukano Optical Brightener | Optical brightener masterbatch in |
| PLA S 515-BL | PLA, Sukano |

### II. Production of the Polymer Films

The polymer films of examples 1-3 (E1-E3) and the comparative example C1 in each case consist of 5-7 layers and have the total layer thicknesses indicated below. The individual layers of the polymer films in each case directly adjoin one another in the order in which they are indicated below. All polymer films of the examples below were produced as cast films by coextrusion of the layers through flat film dies (via a slit die).

### III. Structure of the Polymer Films

All % figures indicated below are in each case percent by weight.

### III.1 Example 1 (E1)

### Total Layer Thickness: 170 μm

TABLE 1

| | | Relative layer |
|---|---|---|
| Layer | Raw materials | thickness |
| 1 | PLA DC S 511 Slip/Antiblock/Clarifier - | 0.12 |
| | 7% (3%) | |
| | PLA 2003 D (97%) | |
| 2 | PLA 2003 D (47.5%) | 0.13 |
| | Compound PLA/PEG-35000S-15% (32.5%) | |
| | Bynel BYN 21 E 787 (20%) | |
| 3 | Coex-Inline PLA (20%) | 0.50 |
| | PLA 2003 D (28%) | |
| | Compound PLA/PEG-35000S-15% (52%) | |
| 4 | PLA 2003 D (47.5%) | 0.13 |
| | Compound PLA/PEG-35000S-15% (32.5%) | |
| | Bynel BYN 21 E 787 (20%) | |
| 5 | PLA DC S 511 Slip/Antiblock/Clarifier - | 0.12 |
| | 7% (3%) | |
| | PLA 2003 D (97%) | |

### III.2 Example 2 (E2)

### Total Layer Thickness: 200 μm

TABLE 2

| | | Relative layer |
|---|---|---|
| Layer | Raw materials | thickness |
| 1 | PLA DC S 511 Slip/Antiblock/Clarifier - | 0.12 |
| | 7% (3%) | |
| | PLA 2003 D (97%) | |
| 2 | PLA 2003 D (57.5%) | 0.13 |
| | Compound PLA/PEG-35000S-15% (32.5%) | |
| | Bynel BYN 21 E 787 (10%) | |
| 3 | Coex-Inline PLA (20%) PLA 2003 D (28%) | 0.50 |
| | Compound PLA/PEG-35000S-15% (51%) | |
| | Sukano Optical Brightener PLA S 515-BL | |
| | (1%) | |
| 4 | PLA 2003 D (57.5%) | 0.13 |
| | Compound PLA/PEG-35000S-15% (32.5%) | |
| | Bynel BYN 21 E 787 (10%) | |
| 5 | PLA DC S 511 Slip/Antiblock/Clarifier - | 0.12 |
| | 7% (3%) | |
| | PLA 2003 D (97%) | |

### III.3 Example 3 (E3)

### Total Layer Thickness: 200 μm

TABLE 3

| | | Relative layer |
|---|---|---|
| Layer | Raw materials | thickness |
| 1 | PLA 2003 D (35%) | 0.16 |
| | Compound PLA/PEG-35000S-15% (65%) | |
| 2 | Coex-Inline PLA (20%) PLA 2003 D (10%) | 0.24 |
| | Compound PLA/PEG-35000S-15% (70%) | |
| 3 | Compound PLA/PEG-35000S-15% (100%) | 0.05 |
| 4 | Compound PLA/PEG-35000S-15% (90%) | 0.10 |
| | Bynel BYN 21 E 830 (10%) | |
| 5 | Compound PLA/PEG-35000S-15% (100%) | 0.05 |
| 6 | Coex-Inline PLA (20%) PLA 2003 D (10%) | 0.24 |
| | Compound PLA/PEG-35000S-15% (70%) | |
| 7 | PLA 2003 D (45%) | 0.16 |
| | Compound PLA/PEG-35000S-15% (55%) | |

### IV.1 Comparative Example (C1) without Bynel Byn 21E787

### Total Layer Thickness: 200 μm

TABLE 4

| | | Relative layer |
|---|---|---|
| Layer | Raw materials | thickness |
| 1 | PLA DC S 511 Slip/Antiblock/Clarifier - | 0.12 |
| | 7% (3%) | |
| | PLA 2003 D (97%) | |
| 2 | PLA 2003 D (45%) | 0.13 |
| | Compound PLA/PEG-35000S-15% (55%) | |
| 3 | Coex-Inline PLA (20%) | 0.50 |
| | PLA 2003 D (20%) | |
| | Compound PLA/PEG-35000S-15% (60%) | |
| 4 | PLA 2003 D (45%) | 0.13 |
| | Compound PLA/PEG-35000S-15% (55%) | |
| 5 | PLA DC S 511 Slip/Antiblock/Clarifier - | 0.12 |
| | 7% (3%) | |
| | PLA 2003 D (97%) | |

### V. Measurement of the Tear Propagation Resistance in Accordance with DIN 53363-Trapez

The tear propagation resistance in the machine direction (md) was determined as rupture force (N) by means of ten measurements on each of the multilayer polymer films E1-E3 and C1 and is shown in table 5 below.

TABLE 5

| | Rupture force (N) in accordance with DIN 53363 - |
|---|---|
| Example | Trapez (md) |
| E1 | 33.5 |
| E2 | 36.7 |
| E3 | 62.2 |
| C1 | 28.4 |

1. A predominantly biodegradable, single-layer or multilayer polymer film consisting of
at least one layer (a) made up of a mixture of at least one biodegradable polymer and up to a maximum of 35% by weight, based on the total weight of the layer (a), of at least one modified, thermoplastic copolymer composed of α,β-unsaturated olefins having 2-10 carbon atoms and (meth)acrylic acid and/or at least one (meth)acrylic acid derivative, which is grafted, of optionally at least one plasticizer and of optionally one or more commonly used additives; and
additionally optionally other layers;
whereby the other layers which are optionally present consist of at least one biodegradable polymer, of optionally a modified, thermoplastic copolymer of α,β-unsaturated olefins having 2-10 carbon atoms and (meth)acrylic acid and/or at least one (meth)acrylic acid derivative, which is grafted, of optionally at least one plasticizer and of optionally one or more commonly used additives,
whereas the total proportion of the modified, thermoplastic copolymers of the polymer film, based on the total weight of the polymer film, is not more than 15% by weight and
the polymer film comprises no adhesion promoting layer.

2. A polymer film as claimed in claim 1, wherein the polymer film is a multilayer film.

3. A polymer film as claimed in claim 1, wherein the modified, thermoplastic copolymer is at least one polymer selected from the group consisting of copolymers of ethylene and methacrylic acid, copolymers of ethylene and methacrylate, copolymers of ethylene and acrylic acid and copolymers of ethylene and acrylate, in each case grafted.

4. A polymer film as claimed in claim 1, wherein the modified thermoplastic copolymer is present in an amount of 1-30% by weight, based on the total weight of the respective layer (a).

5. A polymer film as claimed in claim 1, wherein the total proportion of the modified thermoplastic copolymer in the polymer film is not more than 10% by weight, based on the total weight of the polymer film.

6. A polymer film as claimed in claim 1, wherein each layer is predominantly biodegradable.

7. A polymer film as claimed in claim 1, wherein the biodegradable polymer is at least one biodegradable synthetic polymer selected from the group consisting of lactic acid homopolymers and copolymers, polyhydroxyalkanoates, polyesters derived from lactones having 4 to 10 carbon atoms, and copolymers of at least two monomers of the polymers mentioned and mixtures of at least two of the polymers mentioned.

8. A polymer film as claimed in claim 7, wherein the biodegradable polymer is at least one polylactide, and the polylactide is a poly-L-lactide, poly-D-lactide, poly-DL-lactide or an isomeric, optionally racemic, mixture of poly-L-lactide and poly-D-lactide.

9. A polymer film as claimed in claim 1, wherein the polymer film contains at least one plasticizer in one or more layers.

10. A polymer film as claimed in claim 9, wherein the plasticizer is present in at least one layer (a) in an amount of 1-20% by weight, based on the total weight of the layer (a).

11. A polymer film as claimed in claim 1, wherein the plasticizer content in at least one interior layer is greater than in the surface layers.

12. A polymer film as claimed in claim 1, wherein the polymer film was produced as cast film.

13. A polymer film as claimed in claim 1, wherein the polymer film is transparent or is provided with a layer of self-adhesive material.

14. A method of packaging a consumer good, said method comprising packaging the consumer good in a polymer film as claimed in claim 1.

15. A method of using a polymer film as claimed in claim 1 as viewing window for otherwise nontransparent packaging, as viewing window of envelopes, as stickers which are optionally provided with a pressure-sensitive adhesive layer, as inscribed or uninscribed labels or optionally printed as protective or decorative film for books and cartons.

16. A package comprising a consumer good packaged within a packaging comprising a polymer film as claimed in claim 1.

17. A viewing window, a sticker, a label or a protective or decorative film composed of a polymer film as claimed in claim 1.
